(19) United States
(12) Patent Application Publication
(10) Pub. No.: US 2005/0003168 A1
(43) Pub. Date: Jan. 6, 2005

(54) Method and printed product for producing freely programmable printed images

(75) Inventors: Peter Schmitt, Wurzburg (DE); Siegfried Schmitzer, Kurnach (DE)

Correspondence Address: THE FIRM OF KARL F ROSS, 5676 RIVERDALE AVENUE, PO BOX 900, RIVERDALE (BRONX), NY, 10471-0900, US

(73) Assignee: METRONIC AG

(21) Appl. No.: 10/876,239

(22) Filed: Jun. 24, 2004

(30) Foreign Application Priority Data
Jun. 25, 2003 (DE) 10328741.8

(51) Int. Cl. B32B 3/00

(52) U.S. Cl. 428/195.1

(57) ABSTRACT

The invention relates to a method for printing a surface of a print material with a coating agent to produce a freely programmable printed image, in particular an optical effect, in which a coating agent having at least one temperature-dependent optically variable component is applied, in a first step, to a printing material, at least partially, by a printing process and, in a second step, is subjected to a temperature treatment, at least locally, to produce at least one printed image, in particular an optical effect of the printing material, in particular the printed surface of the printing material. Furthermore, the invention relates to a printed product having a coating agent applied to it, in which the coating agent has at least one temperature-dependent optically variable component, in particular liquid crystals, to produce a variable printed image, in particular at least one optical effect.

The invention relates to a method for printing a surface of a printing material with a coating agent to produce a freely programmable printed image, in particular an optical effect. Furthermore, the invention relates to a printed product for producing a freely programmable printed image.

In the prior art, it is known to produce printed products by means of many different printing processes. The disadvantage of the processes and printed products is a non-variable printed image which can not be changed after being printed. For example, special printing cylinders with prefabricated cliches are used in printing machines. If the printed image is to be changed, the cliche of a printing cylinder must be changed.

Variable printed images can, for example, only be produced by computer-controlled printers, however, a variably produced printed image of this type can also no longer be subsequently changed.

The object of the invention is to provide a method and a printed product by means of which variable printed images can be produced and preferably subsequently changed.

This object is solved in that a coating agent with at least one temperature-dependent optically variable component is applied to a printing material, at least partially, in a first step by any printing process desired, whether it be cliche bound or not cliche bound, and is subjected, in a second step, to a temperature treatment, at least locally, to produce at least one printed image, in particular a first optical effect of the printing material, in particular the printed surface of the printing material.

A printed product produced in this way thus has a coating agent with at least one temperature-dependent optically variable component by means of which a variable printed image can be produced. Provided that the optical variability remains intact at least over a longer period of time, it is also possible to change the printed image, at least within this period of time.

The essential point is that the coating agent comprises an optically variable component whose optical properties are temperature-dependent. In this way, by a specific e.g. local temperature treatment of the coating agent or the printed material, in particular its surface, the optical appearance can be influenced and freely programmable printed images produced in this way.

A temperature treatment can take place e.g. by a particularly locally limited cooling or heating, the different temperature treatments also being able to have different effects on the optical appearance of the printed image produced with it. In particular, different temperature treatments can be performed successively to change the printed image again and again. For example, first by a heating and then by a cooling.

A temperature treatment of this type can be produced by any possible device which makes it possible to cause a change in the temperature of the coating agent, in particular, one that is locally limited. This can be accomplished by thermotransfer strips, heated or cooled stamps, radiation sources, for example, (programmable) lasers, etc.

For example, a temperature treatment can produce a specific alignmnt or a change in an alignment, at least of an optically variable component in the coating agent.

This can be obtained e.g. when the coating agent comprises one or more liquid crystal components since liquid crystals have optically anisotropic properties and can thus produce the effect of a birefraction by means of which the visual appearance of the printed image can be affected. Thus, a printed image can have e.g. an optically birefractive marking.

To avoid a continuous variability of the printed image, it can be provided that the coating agent be hardened, in particular, by radiation and to thus fix the printed image. In this hardened state, the printed image is independent of temperature.

Due to the special optical effects which can thus be obtained, in particular, due to the optical properties of liquid crystals, printed products thus produced are quite suitable as a decorative element, valuable document, security element, authenticity element, data carrier, colour transfer film, reflective film, as an identification element, i.e. in particular in security-relevant fields, to prevent forgery, counterfeiting, access authorizations or the like.

A concrete example of an embodiment will be described in greater detail in the following.

E.g. hardenable inks or lacquers which contain liquid crystals (LC) are printed onto a substrate surface in a first step by means of a printing process. In a subsequent process step, a solvent contained therein is extracted from the applied layer with suitable means. The components of the LC ink thereby align themselves more or less perfectly depending on the prevailing temperature (primary alignment process).

Subsequently, a secondary alignment takes place at a clearly different, usually higher temperature, in that a local change in temperature of the printed layer is produced point by point by, for example, guiding a thermotransfer strip of a thermotransfer printer over the printed area.

Since the individual print elements of the thermotransfer strip can be specifically controlled, the desired (secondary) alignment effects are freely programmable. Depending on the temperature, either the primary alignment is thereby cancelled or another optical effect than with the first alignment is obtained. By repeated subsequent secondary alignment processes, images can be produced in this way, with suitable selection of the liquid crystals, which have several different optical effects or polychromatism. In a subsequent hardening, for example by photopolymerization, these states are permanently fixed. It can be advantageous to perform this hardening during the temperature treatment or immediately thereafter, especially if the hardening is slow, to make the difference between the primary alignment and secondary alignment especially visible.

Nematic or cholesterol LC systems of the firm Merck KGaA can e.g. be used as liquid crystal components. The LC systems can thereby be applied directly or as an additive to other coating agents. With direct application, the LC systems can be heated and processed as a melt or they can also be used with solvents.

The fact that non-hardened nematic or cholesterol phases of the liquid crystals have a temperature dependency with respect to the obtainable optical properties and exhibit optical effects, which is reflected, for example, in a change of the wavelengths of the reflected inks, is made use of in this case. In particular, the orientation of the liquid crystals, i.e. the so-called alignment process, can be influenced. These types of liquid crystal printing inks can be polymerized by means of actinic radiation in spite of a solvent constituent.

If the solvent is evaporated in these printing inks with liquid crystals, then the remaining components tend to bond to one another as the components of a crystal in a macroscopic arrangement. In an ideal case, this type of crystallinity exists in a complete arrangement of all molecules, the type and manner of arrangement depending on the type of liquid crystal used.

Thus, the arrangement can, for example, be linear or helix-like, which results in different optical effects. In any event, however, a periodicity results in the arrangement. This straightening is also called alignment. The dimensions of the periodicity are hereby in the range of wavelengths of the visible light, as a result of which the respective visible optical effects are produced due to the Bragg scattering or wavelength-dependent absorption or reflection or a change of the polarization property of the incident light.

This can also mean that, depending on the viewing angle, various spectral ranges of the visible light are reflected or that areas such as texts or images can exhibit different optical properties such as colour or polarization state.

The components used essentially consist of polymerizable monomers, so that the conditions formed in the alignment process can be fixed by radiation with UV light and the optical effects can thus be permanently retained. This fixing takes place in a subsequent step using suitable UV ray emitters.

The alignment process and thus the fact of whether and to what extent a crystalline arrangement is established, depends on various parameters. The crystalline arrangement is affected by the rate of evaporation of the organic solvent and by the prevailing temperature during and after evaporation of the solvent.

Mechanically, a locally limited heating is easier to realize than a corresponding cooling. For example, a thermotransfer printer can be used in this case. The basic part of this technology is a thermotransfer strip whose individual areas can be specifically controlled and heated with aid of a computer. In the resultant print, a resolution of e.g. up to 300 dpi is attained, i.e. the thermotransfer technology can be used in a defined manner to influence the alignment process of the above-described LC inks with such a resolution.

In the first step, a printed image of a solvent-containing LC ink, e.g. from the firm Merck KGaA, is applied to a film via e.g. a flexo printing mechanism, the dimensions of the print being predetermined, inter alia, by both the cliche used and the cliche cylinder. The term “printed image” thereby refers to images and symbols in the order of magnitude of fractions of mm up to complete surfaces, depending on the requirement.

The primary alignment process follows the ink application in the course of the evaporation of the solvent, the result of said alignment process being strongly dependent on the prevailing temperatures of the LC ink itself which, in turn, are closely associated with the temperatures of film and surroundings. In this case, temperatures of between 20° C. and 50° C. are preferably selected, temperatures of between 30° C. and 35° C. are especially preferred for optimal alignment. Other temperatures could lead to clearly other or also inadequate or missing optical effects due to inadequate alignment effects which might, however, be desired.

In the second step, a locally defined additional change in the alignment is made with aid of a thermotransfer strip guided above or below the resultant LC layer or the printing material (like the film in this case). In this way, the resultant optical effect can be specifically changed point by point by settting the temperature in a variable manner. By using a freely programmable thermotransfer printing unit, it is thus possible to insert variable data and images in an aforementioned LC layer. Alternatively, the heat treatment can also take place by the use of lasers, a change in temperature being produced locally by the action of the laser radiation on the liquid crystal printing ink and/or the substrate.

In the last step, this is followed by the drying process which can be carried out under inert gas (nitrogen or argon) due to the radically hardening components of the LC inks of the firm Merck KGaA. In principle. all radiation sources which have a corresponding UV initial output in the required wavelength range are suitable for the hardening. Preferably, radiation sources are used in this case which, in addition to a high UV output, do not cause any additional heat stress on the liquid crystal layer which would result in a change or destruction of the optical effect produced. In this example, several mercury low-pressure lamps are used which can, in addition to the pure 254 nm mercury line, also exhibit other wavelength ranges in the UV-A, UV-B and/or UV-C due to coatings of the quartz glass. Due to the advantageous temperature profile of these radiation sources, there are no further temperature stresses on the LC inks during the drying process, so that the previously produced zones of different alignments are no longer changed.

By selecting the temperatures noted in the individual steps, the most varied optical effects can be realized, e.g. a printed image which appears green when viewed from the top in a blue surrounding (positive) or, vice versa, a blue printed image (negative) in a green-appearing surrounding (negative). Colour impressions of this type can, in addition to the viewing angle, also be dependent on the choice of LC. By using several secondary alignment processes, several different optical effects can also be produced in this way, for example, by applying different temperatures on adjacent individually controlled points. In this way, for example, multicoloured images can be produced whose colour impressions are brought about by colour triples, similarly as in television sets. It is also possible to print several LC layers on top of one another and to subject one or more of the applied layers to the method of the invention.

Further possibilities result by using mixtures of LC inks. The number of possible printing effects are limitless. It is also possible to apply the described method to other, e.g. cationically hardening LC inks. As a result thereof, the use of inert gas in the drying process can be omitted, which is associated with a great equipment outlay.

1. A method for printing a surface of a printing material with a coating agent to produce a freely programmable printed image, in particular an optical effect, characterized in that, in a first step, a coating agent having at least one temperature-dependent optically variable component is applied to a printing material, at least partially, by a printing process and, in a second step, is subjected to a temperature treatment, at least locally, to produce at least one printed image, in particular an optical effect of the printing material, in particular the printed surface of the printing material:

2. The method according to claim 1, characterized in that the printing material, in particular the printed surface thereof, is subjected, at least partially, to at least one further temperature treatment, in particular a local temperature treatment, in particular one that differs from a prior temperature treatment.

3. The method according to claim 2, characterized in that a temperature treatment takes place by a cooling and/or heating, in particular to produce a printed image.

4. The method according to claim 1, characterized in that the coating agent comprises at least one liquid crystal component.

5. The method according to claim 1, characterized in that the coating agent is hardened on the printed surface to fix the optical effect, in particular by radiation.

6. The method according to claim 5, characterized in that the properties of the printed image, in particular the optical effect of the coating agent, are temperature-dependent in the hardened state.

7. The method according to claim 1, characterized in that a temperature treatment is carried out with a thermotransfer strip.

8. The method according to claim 1, characterized in that a temperature treatment is carried out with a heated stamp.

9. The method according to claim 1, characterized in that the temperature treatment is carried out with at least one radiation source, in particular a controllable one, in particular a laser.

10. The method according to claim 1, characterized in that several layers of a coating agent with optically variable components are applied to a printing material which are each subjected to a temperature treatment.

11. A printed product having a coating agent applied to it, in particular, produced with a method according to claim 1, characterized in that the coating agent has at least one temperature-dependent optically variable component, in particular liquid crystals, to produce a variable printed image, in particular at least one optical effect.

12. The printed product according to claim 11, characterized in that an alignment and/or a change in an alignment of at least one optically variable component can be produced by means of a local temperature treatment, in particular to obtain an optical effect.

13. The printed product according to claim 11, characterized in that it contains a marking based on birefraction.

14. The printed product according to claim 11, characterized in that it contains at least one coloured marking dependent on the viewing angle.

15. Use of a printed product according to claim 11 as a decorative element, a valuable document or as a part thereof, security element, authenticity element, data carrier, colour-transfer film, reflective film or as an identification element.
